(19) United States
(12) Patent Application Publication
(10) Pub. No.: US 2011/0180222 A1
(43) Pub. Date: Jul. 28, 2011

(54) Window Blind

(76) Inventor: Jieh-Ren Huang, Yongan Hsiang (TW)

(21) Appl. No.: 12/692,019

(22) Filed: Jan. 22, 2010

(51) Int. Cl. E06B 9/24

(52) U.S. Cl. 160/368.1

(57) ABSTRACT

A window blind includes a mounting seat, a window blind unit, and a protection unit. The window blind unit includes a shading member mounted to the mounting seat, a driver disposed on the mounting seat, and a cord. The cord has a connecting segment extending through and connected to the shading member, and a pulling segment passed through and at least partially extending outside of the driver. The shading member is moveable between a fully unfolded position and a fully folded position by manipulation of the pulling segment of the cord and by cooperation of the cord with the driver. The protection unit includes a protection sleeve and a plurality of connecting components spaced vertically apart from each other and interconnecting the protection sleeve and the shading member. The protection sleeve has a passage through which the connecting segment of the cord extends.

### BACKGROUND OF THE INVENTION

1. Field of the Invention

The present invention relates to a window blind, more particularly to a window blind with an improved structure to provide for enhanced safety.

2. Description of the Related Art

Referring to FIG. 1, a conventional window blind 1 includes a mounting seat 11, two or more positioning strings 12, a plurality of curtain pieces 13 horizontally disposed and connected in a side-by-side manner through cooperation with the positioning strings 12, a driver 14 disposed on the mounting seat 11, and two pulling cords 15 extending through the driver 14 and connected to the curtain pieces 13. Each of the cords 15 has a connecting segment 16.

The curtain pieces 13 are pulled up and down along a direction 10 by manipulation of the cord 15 and by cooperation of the cord 15 with the driver 14 to adjust a shading height.

However, the conventional window blind 1 has some disadvantages. For example, it is possible for the cord to wrap around a child's neck, thereby causing strangling injury. Moreover, the connecting segment 16 of the cord 15 running at the back side of the curtain pieces 13 may also cause strangling injury if a child sticks his/her head in between the curtain pieces 13 and any one of the connecting segments 16 of the cords 15. Therefore, the conventional window blind 1 is dangerous, particularly to children.

### SUMMARY OF THE INVENTION

Therefore, the object of the present invention is to provide a window blind which is safe.

Accordingly, a window blind of the present invention comprises a mounting seat, a window blind unit, and a protection unit.

The window blind unit includes a shading member mounted to the mounting seat, a driver disposed on the mounting seat, and a cord. The cord has a connecting segment extending through and connected to the shading member, and a pulling segment passed through and at least partially extending outside of the driver. The shading member is moveable between a fully unfolded position and a fully folded position by manipulation of the pulling segment of the cord and by cooperation of the cord with the driver.

The protection unit includes a protection sleeve and a plurality of connecting components spaced vertically apart from each other and interconnecting the protection sleeve and the shading member. The protection sleeve has a passage through which the connecting segment of the cord extends.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional window blind;

FIG. 2 is a perspective view of a window blind according to a first preferred embodiment of the present invention, illustrating a shading member in a fully unfolded position;

FIG. 3 is a fragmentary side view of the window blind according to the first preferred embodiment of the present invention, illustrating connecting components interconnecting a protection sleeve and the shading member, and illustrating the shading member in a partially folded position;

FIG. 4 is a view similar to FIG. 3, but illustrating the shading member in a fully unfolded position;

FIG. 5 is a fragmentary side view of a protection unit of a window blind according to a second preferred embodiment of the present invention;

FIG. 6 is a fragmentary side view of the window blind of the second preferred embodiment, illustrating an assembly of the protection unit and the shading member;

FIG. 7 is a fragmentary side view of a protection unit of a window blind according to a third preferred embodiment of the present invention;

FIG. 8 is a fragmentary side view of the window blind of the third preferred embodiment, illustrating an assembly of the protection unit and the shading member;

FIG. 9 is a fragmentary side view of a protection unit of a window blind according to a fourth preferred embodiment of the present invention; and

FIG. 10 is a fragmentary side view of the window blind of the fourth preferred embodiment, illustrating an assembly of the protection unit and the shading member.

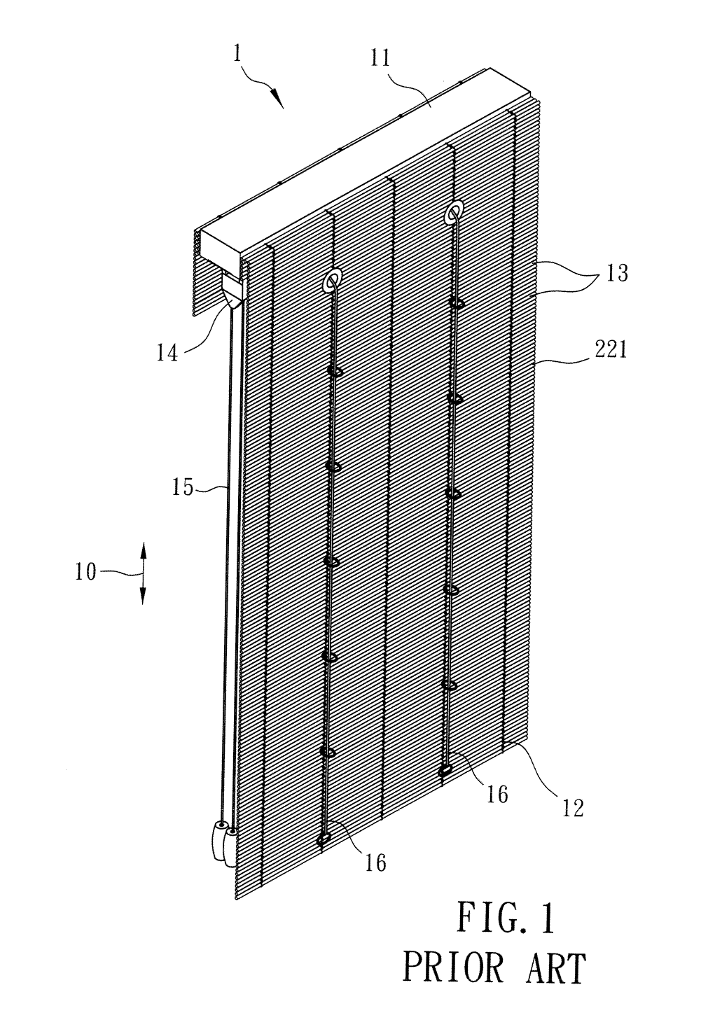

### DETAILED DESCRIPTION OF THE PREFERRED EMBODIMENTS

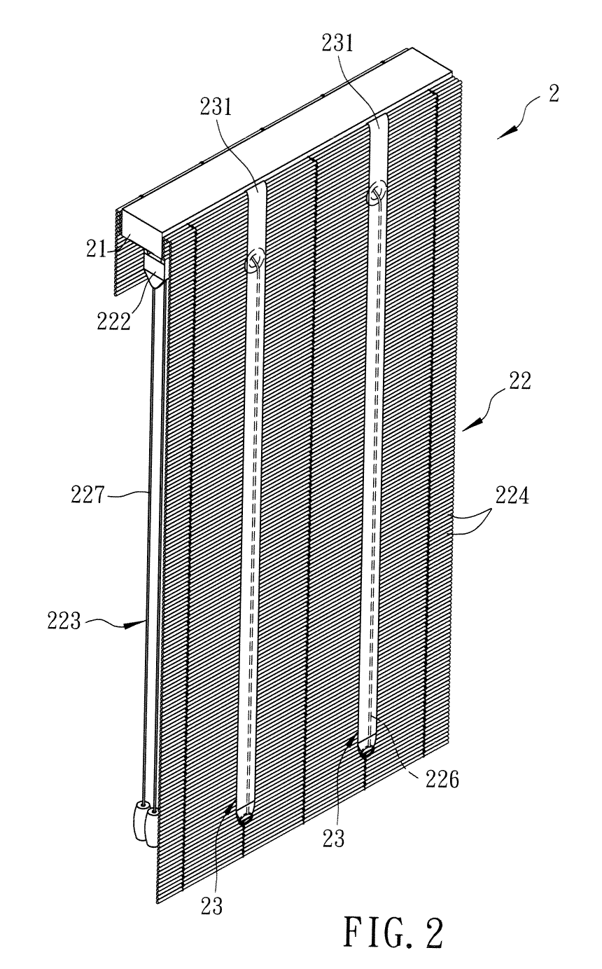

Referring to FIG. 2, a first preferred embodiment of a window blind 2 according to the present invention is shown to comprise amounting seat 21, a window blind unit 22 mounted to the mounting seat 21, and a protection unit 23 connected to the window blind 22.

Referring to FIGS. 2,3, and 4, the window blind unit 22 includes a shading member 221, a driver 222, and a cord 223. The shading member 221 is mounted to the mounting seat 21. The driver 222 is disposed on the mounting seat 21. The cord 223 extends through the driver 222 and the shading member 221.

The shading member 221 has a plurality of horizontal shade components 224 connected ma side-by-side manner. In this embodiment, each of the shade components 224 is formed as a long element in circular shape, and all of the shade components 224 are woven together using a thread material 225.

The cord 223 has a connecting segment 226 extending through and connected to the shading member 221, and a pulling segment 227 passed through and at least partially extending outside of the driver 222.

The protection unit 23 includes a protection sleeve 231 and a plurality of connecting components 232 spaced vertically apart from each other and interconnecting the protection sleeve 231 and the shading member 221. In this embodiment, the protection sleeve 231 is made of woven cloth material, but is not limited thereto, and may be made of any flexible material. The protection sleeve 231 has a passage 233 through which the connecting segment 226 of the cord 223 extends.

Each of the connecting components 232 includes a guide ring 239 connected to one of the shade components 224 of the shading member 221 using the thread material 225. The guide ring 239 may be sewed to the protection sleeve 231 using a thread piece 2324 or hooked onto protection sleeve 231.

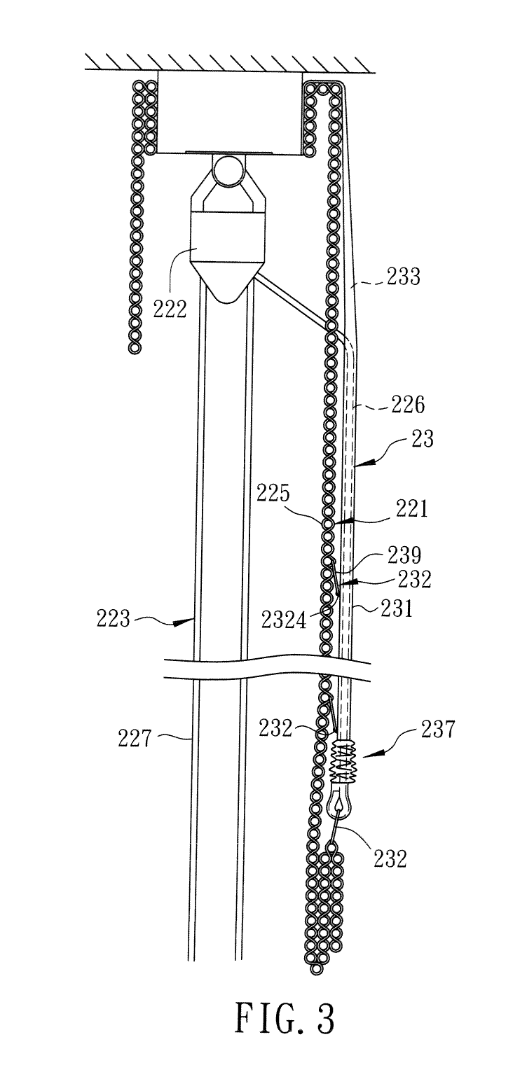

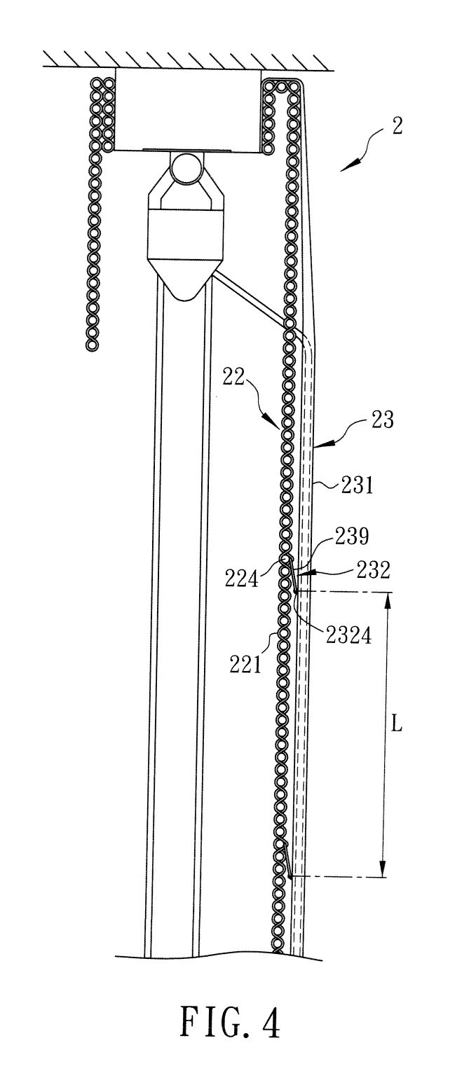

When the window blind 2 of the present invention is in use, the shading member 221 is moveable between a fully unfolded position as shown in FIG. 2, a partially folded position as shown in FIG. 3, and a fully folded position (not shown) by manipulation of the pulling segment 227 of the cord 223 and by cooperation of the cord 223 with the driver 222.

The protection sleeve 231 is made of a soft fiber material, such that the protection sleeve 231 is progressively gathered together starting from a bottom end thereof to form a shrinking segment 237 (see FIG. 3) between the connecting components 232 as the shading member 221 is folded.

It is to be noted that research has indicated that the average circumference of a pre-school child's head is not less than eight inches. Therefore, in some embodiments, a spacing between two adjacent ones of the connecting components 232 is less than eight inches. Also, the protection sleeve 231 fully surrounds the connecting segment 226 of the cord 223 when the shading member 221 is in a fully unfolded position. Consequently, strangling injury can be avoided effectively. In this embodiment, each of the shade components 224 of the shading member 221 is in the shape of a long element, and is woven with adjacent ones thereof to form a roman curtain. However, the shade components 224 are not limited to such a configuration. Any other materials and/or fabrics and/or interconnecting methods may be used. For example, the shade component 224 may be a wood piece or a bamboo piece or a piece of fabric, and each of the guide rings 239 may be connected to the thread material 225 of the corresponding shade component 224 as described above.

It is to be noted that in the description given above and to follow, the window blind 2 is described as including only one protection unit 23 and one cord 223. However, in some embodiments, there may be two or more cords 223 of the window blind unit 22, and correspondingly, two or more protection units 23 as shown in the drawings.

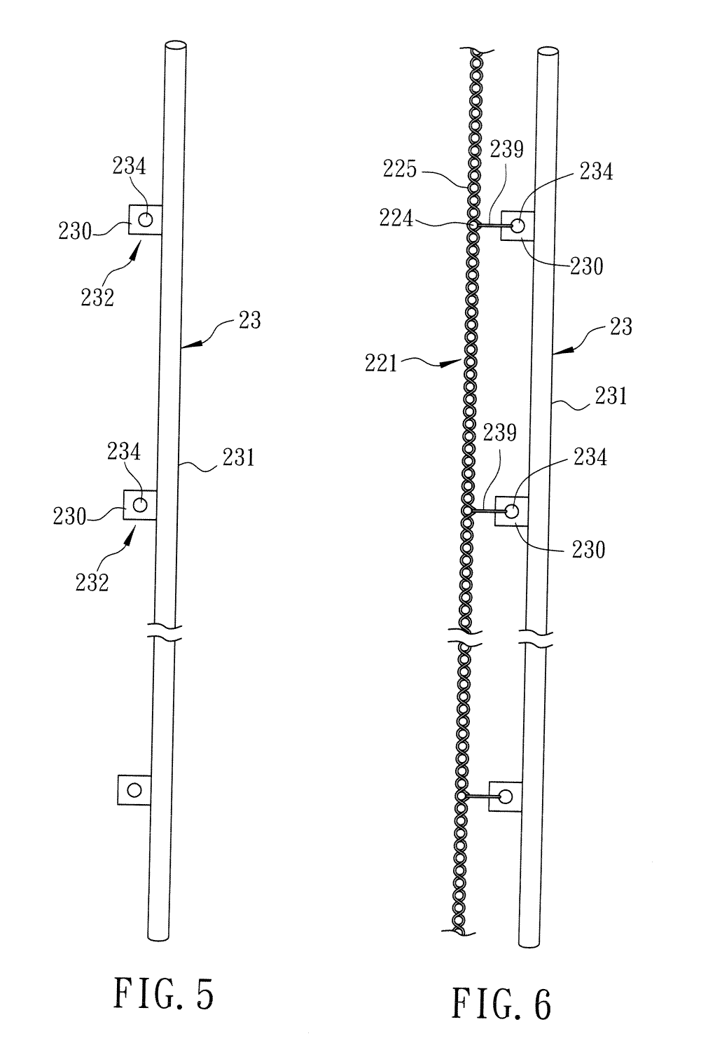

FIGS. 5 and 6 illustrate a second preferred embodiment of the window blind according to the present invention. The second preferred embodiment differs from the first preferred embodiment in the following aspects.

Each of the connecting components 232 includes a flap connector 230 connected to the protection sleeve 231, and a guide ring 239. The flap connector 230 is formed with a hole 234. The guide ring 239 extends through the hole 234, and is connected to the thread material 225 on the shade components 224 of the shading member 221. In the second preferred embodiment, a spacing between two adjacent ones of the flap connectors 230 is less than eight inches, thereby improving safety as described above with reference to the first preferred embodiment.

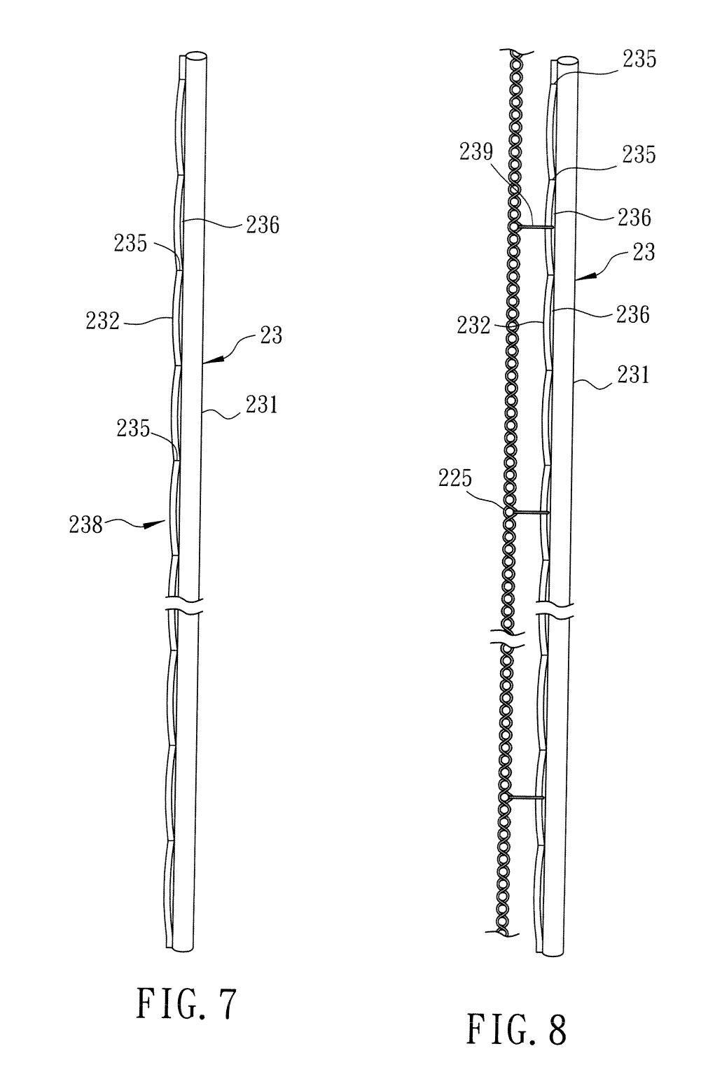

FIGS. 7 and 8 illustrate a third preferred embodiment of the window blind according to the present invention. The third preferred embodiment differs from the first preferred embodiment in the following aspects.

The protection unit 23 includes a rectangular strip 238 and a plurality of guide rings 239. The rectangular strip 238 is sewed to the protection sleeve 231 by a plurality stitches 235 which are vertically and substantially equidistantly spaced apart so as to define a plurality of gaps 236 between the strip 238 and the protection sleeve 231. The guide rings 239 extend respectively through select ones of the gaps 236 and are connected to the thread material 225 on the shade components 224 of the shading member 221. Each of the connecting components 232 is formed by a portion of the strip 238 between two adjacent ones of the stitches 235 and a corresponding one of the guide rings 239.

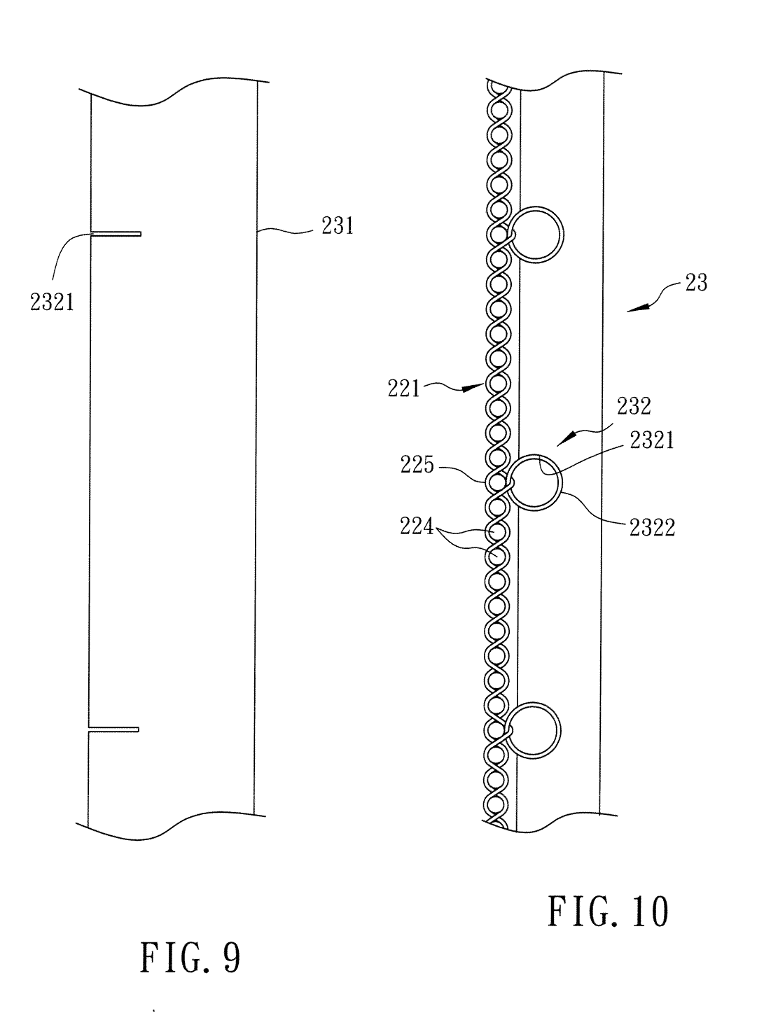

FIGS. 9 and 10 illustrate a fourth preferred embodiment of the window blind according to the present invention. The fourth preferred embodiment differs from the first preferred embodiment in the following aspects.

Each of the connecting components 232 includes a positioning hole 2321 formed in the protection sleeve 231, and a fastening member 2322 disposed on the shading member 221 and engaged with the positioning hole 2321 such that the protection sleeve 231 is secured to the shading member 221. The fastening member 2322 is one of a hollow disk-shaped element and a solid disk-shaped element. In some embodiments, the positioning hole 2321 is in the form of a button hole, and the fastening member 2322 is in the form of a button.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A window blind comprising:
a mounting seat;
a window blind unit including a shading member mounted to said mounting seat, a driver disposed on said mounting seat, and a cord having a connecting segment extending through and connected to said shading member, and a pulling segment passed through and at least partially extending outside of said driver, said shading member being moveable between a fully unfolded position and a fully folded position by manipulation of said pulling segment of said cord and by cooperation of said cord with said driver; and
a protection unit including a protection sleeve and a plurality of connecting components spaced vertically apart from each other and interconnecting said protection sleeve and said shading member, said protection sleeve having a passage through which said connecting segment of said cord extends.

2. The window blind as claimed in claim 1, wherein said protection sleeve is made of a soft fiber material, such that said protection sleeve is progressively gathered together starting from a bottom end thereof as said shading member is folded.

3. The window blind as claimed in claim 1, wherein a spacing between two adjacent ones of said connecting components is less than eight inches.

4. The window blind as claimed in claim 1, wherein said shading member has a plurality of horizontal shade components connected in a side-by-side manner, each of said connecting components including a guide ring interconnecting one of said shade components and said protection sleeve.

5. The window blind as claimed in claim 4, wherein each of said shade components is formed as a long element with a substantially circular cross section that is one of hollow and solid, and is woven with adjacent ones of said shade components using a thread material.

6. The window blind as claimed in claim 1, wherein each of said connecting components includes a positioning hole formed in said protection sleeve, and a fastening member disposed on said shading member and engaged with said positioning hole such that said protection sleeve is secured to said shading member.

7. The window blind as claimed in claim 6, wherein said fastening member is one of a hollow disk-shaped element and a solid disk-shaped element.

8. The window blind as claimed in claim 1, wherein said protection unit includes a rectangular strip and plurality of guide rings, said rectangular strip being sewed to said protection sleeve by a plurality stitches which are vertically and substantially equidistantly spaced apart so as to define a plurality of gaps between said strip and said protection sleeve, said guide rings extending respectively through select ones of said gaps and being connected to said shading member, each of said connecting components being formed by a portion of said strip between two adjacent ones of said stitches and a corresponding one of said guide rings.

9. The window blind as claimed in claim 1, wherein each of said connecting components includes a flap connector connected to said protection sleeve, and a guide ring, said flap connector being formed with a hole, said guide ring extending through said hole and being connected to said shading member.

10. The window blind as claimed in claim 1, wherein each of said connecting components includes a guide ring connected to said shading member, said guide ring being sewed to said protection sleeve using a thread piece.
